(19) United States
(12) Patent Application Publication
(10) Pub. No.: US 2004/0044659 A1
(43) Pub. Date: Mar. 4, 2004

(54) Apparatus and method for searching and retrieving structured, semi-structured and unstructured content

(76) Inventors: Douglass Russell Judd, Burlingame, CA (US); Bruce D. Karsh, Half Moon Bay, CA (US); Ram Subbaroyan, San Francisco, CA (US); Troy Toman, San Carlos, CA (US); Rahul Lahiri, Belmont, CA (US); Patrick Lok, Foster City, CA (US)

Correspondence Address: COOLEY GODWARD, LLP, 3000 EL CAMINO REAL, 5 PALO ALTO SQUARE, PALO ALTO, CA, 94306, US

(21) Appl. No.: 10/439,338

(22) Filed: May 14, 2003

Related U.S. Application Data
(60) Provisional application No. 60/380,763, filed on May 14, 2002.

(51) Int. Cl. G06F 7/00

(52) U.S. Cl. 707/3

(57) ABSTRACT

A search and retrieval permits a user to search free text within sections of schema independent documents. The documents, which may include structured, semi-structured, and unstructured documents, contain text organized into a plurality of sections, such as XML tags. The repository of documents is schema independent, such that the search system does not require pre-defined fields for the sections. To execute a search, the search system receives a query that specifies at least one section and at least one free text query construct for text within the section. In general, the free text query construct specifies at least one free text search condition. The search system identifies sections in the repository of documents as specified in the query, and evaluates the free text query construct for the text within sections to determine whether the free text search condition is met.

### CROSS REFERENCE TO RELATED APPLICATIONS

This application claims the benefit of U.S. Provisional Patent Application No. 60/380,763, filed May 14, 2002, entitled “Search and Retrieval System for Structured and Unstructured Content.”

This application is related to U.S. Ser. No. __/___,___, filed May 14, 2003, entitled “Apparatus and Method for Region Sensitive Dynamically Configurable Document Relevance Ranking,” which is assigned to the assignee of the present invention and which is incorporated herein by reference.

### FIELD OF THE INVENTION

Generally, the present invention is related to search systems. More particularly, the present invention is directed toward searching structured, semi-structured, and unstructured data.

### BACKGROUND OF THE INVENTION

In general, search and retrieval systems operate on a repository of information and allow a user to search for information within the repository of information. To locate information within the repository of information, the user formulates a query. In response, the system executes the query by locating information that satisfies the search criteria specified in the query. The repository of information may include documents.

Search and retrieval systems require a way to store information. Databases are commonly used to store and organize data. Generally, to use a database to store data, a user specifies a schema. The schema defines pre-determined fields to store data. For example, in relational databases, the user defines columns for database tables to define a format for data stored within the columns of the database table. For example, a user may specify that a column store floating point numbers or that a column store a character string. Generally, databases use a formal query language to find data stored in the database. One type of a formal query language is the standard query language (“SQL”). To search for data in the database, the user specifies a query in accordance with the formal query language. Databases are well suited for certain applications. For example, databases allow a user to execute range queries on fields of the database that specify numeric values (i.e., identify all fields between the values of 8 and 10). However, databases are rigid for the users because they require the user to allocate the data into pre-defined fields. If the user of a search and retrieval system imports documents for searching, then storing the documents in a rigid database structure is unworkable. Accordingly, it is desirable to develop a search and retrieval system that does not require a pre-determined schema for documents (i.e., schema independent documents).

Although documents of a search and retrieval system may not adhere to a single rigid schema, some documents may include structure in the form of fields or tags. The eXtensible Markup Language (“XML”) is a universal format for structured documents and data on the World Wide Web. Through use of XML, documents may include structure by defining XML tags. In order to maximize the capabilities of the system, it is desirable to develop a search and retrieval system that permits a user to search on sections of a document, such as sections defined by XML tags.

The document may also include, within the tags or fields, free text. For example, a resume may include some predefined fields, such as education and job experience. Within the education and job experience fields, the example document may include free text (i.e., describing the person's education and job experience). For this example, the user of a search and retrieval system may desire to search on free text only within the education and job experience fields. Thus, it is desirable to develop a search and retrieval system that permits a user to search on free text within only sections of a document. As described herein, the search system of the present invention permits conducting searches on structured, semi-structured and unstructured data within documents.

### SUMMARY OF THE INVENTION

A search and retrieval technique permits a user to search free text within sections of documents. At least some of the documents contain text organized into sections. The documents may include structured, semi-structured, and unstructured documents. In one embodiment, the sections comprise structured fields, such as XML tags. The repository of documents is schema independent, such that the search system does not require pre-defined fields for the sections.

To execute a search, the search system receives a query that specifies at least one section and at least one free text query construct for text within the section. In general, the free text query construct specifies at least one free text search condition. The search system identifies sections in the repository of documents as specified in the query, and evaluates the free text query construct for the text within sections to determine whether the free text search condition is met.

### BRIEF DESCRIPTION OF THE DRAWINGS

FIG. 1 is a block diagram illustrating one embodiment of the search system of the present invention.

FIG. 2 illustrates examples of different types of data available in the search system of the present invention.

FIG. 3a illustrates an example XML document for use in the searching system of the present invention.

FIG. 3b illustrates a tree structure for the XML document of FIG. 3a.

FIG. 4 is a block diagram illustrating one embodiment of the search system of the present invention.

FIG. 5 is a flow diagram illustrating one embodiment for processing input documents to the search system.

FIG. 6 is a block diagram illustrating one embodiment for inserting documents into the search system.

FIG. 7 is a block diagram illustrating one embodiment for a merge process performed in accordance with an embodiment of the invention.

FIG. 8 is a flow diagram illustrating one embodiment of a merge process to combine indices in the search system.

FIG. 9 is a block diagram illustrating one embodiment for an index of the search system.

FIG. 10 is a block diagram illustrating one embodiment for information contained in a position vector.

FIG. 11 is a flow diagram illustrating one embodiment for processing queries in the search system.

FIG. 12 is another flow diagram illustrating one embodiment for executing a query in the search system of the present invention.

FIG. 13 illustrates a query tree for the example query “//name=Joe Blow AND 1=1.”

FIG. 14 illustrates a high-level block diagram of a general-purpose computer system for operating the search system of the present invention.

### DETAILED DESCRIPTION OF THE INVENTION

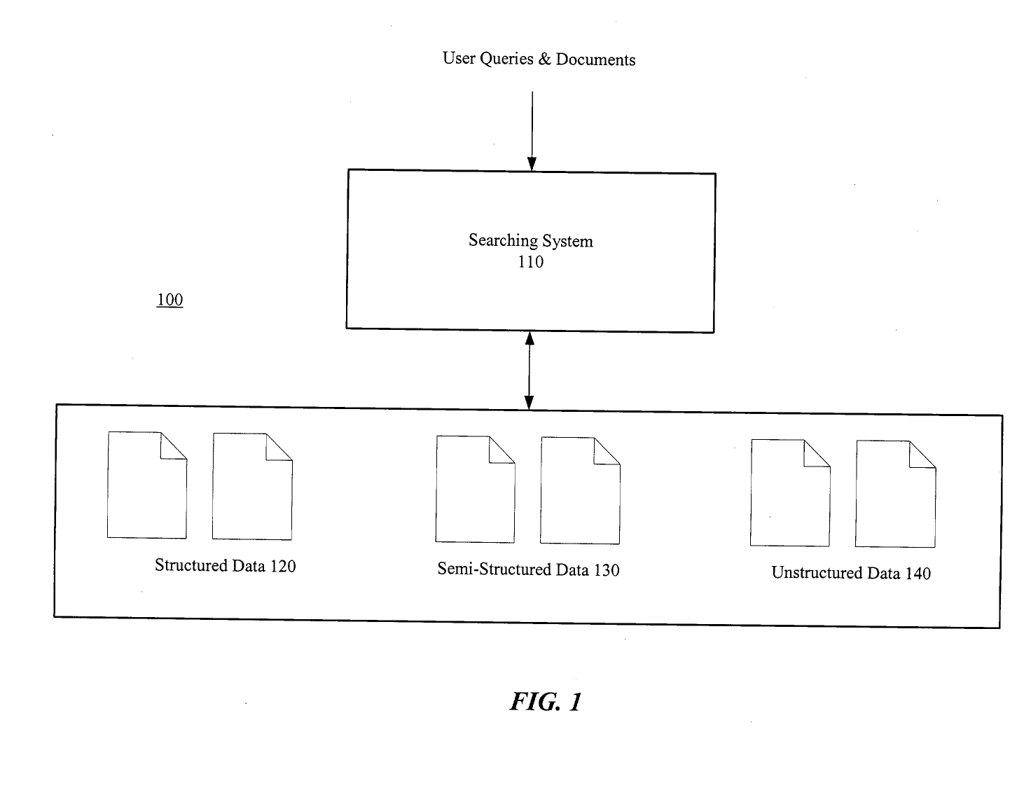

FIG. 1 is a block diagram illustrating one embodiment of the search system of the present invention. The system 100 receives user queries and documents at a searching system module 110. The searching system module 110 includes executable instructions to store and subsequently search structured data 120, semi-structured data 130, and unstructured data 140.

In general, the search system operates to permit users to find specific information within a repository of information or documents. For this embodiment, the document repository includes structured data, unstructured data, and semi-structured data. As used herein, “structured data” connotes data that is organized in a predetermined schema. For example, data, organized in fields of a relational or object oriented database, is considered structured data. In a relational database, the data is stored in tables. Each table has predefined columns or fields that specify the type of data stored in that column for each entry or row in the database table. Relational databases have application for manipulating numeric data. For example, the field may specify an integer value to represent a day of the week (e.g., 1-7), and each row in the table may store a value from 1-7. Although structured data stored in databases provides an efficient means for organizing and searching data in some applications, databases are very rigid because all data must be placed in a predefined field.

As used herein, “semi-structured” data connotes data that has one or more identifiers, but each portion of the data is not necessarily organized in predefined fields. Examples of semi-structured data include documents tagged using a markup language, such as the extensible Markup Language (“XML”). A semi-structured document may have text associated with a field. However, the amount of text may vary because the field or tag does not specify a predetermined length of text. A third type of information stored in the search system of the present invention is “unstructured data.” As used herein, “unstructured data” connotes data that is not identified using predefined fields tags. For example, unstructured data may include textual documents.

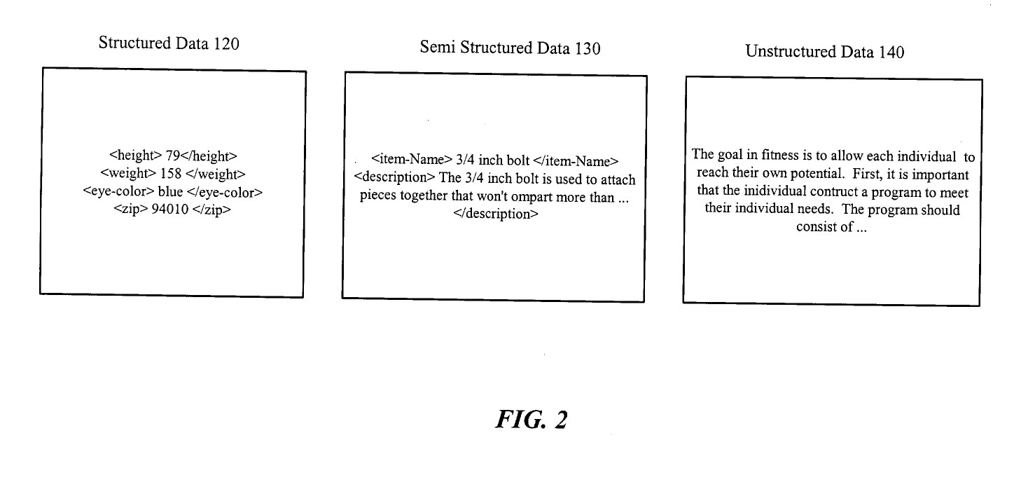

FIG. 2 illustrates examples of different types of data available in the search system of the present invention. The example for structured data 120 includes XML elements and corresponding values for those elements. The example structured data 120 specifies attributes associated with a person, such as height, weight, eye color, and zip code. Semi-structured data 130 also includes XML elements and corresponding data. For example, semi-structured data 130 includes the element “item-name”, and the associated value “¾ inch bolt.” In addition, semi-structured data 130 includes a general description of the item-name. Specifically, under the “description” tag, a free text description is provided to describe the item-name (e.g., ¾ inch bolt). The example data shown for unstructured data 140 in FIG. 2 is free text. For this example, no XML tags are provided.

In one embodiment, the structure of data in a document uses XPath. XPath uses a notation similar to that used in URIs to represent the address of data in an XML document. This address is referred to as a “location path.” Each XML document may be represented as a tree consisting of a hierarchy of element nodes.

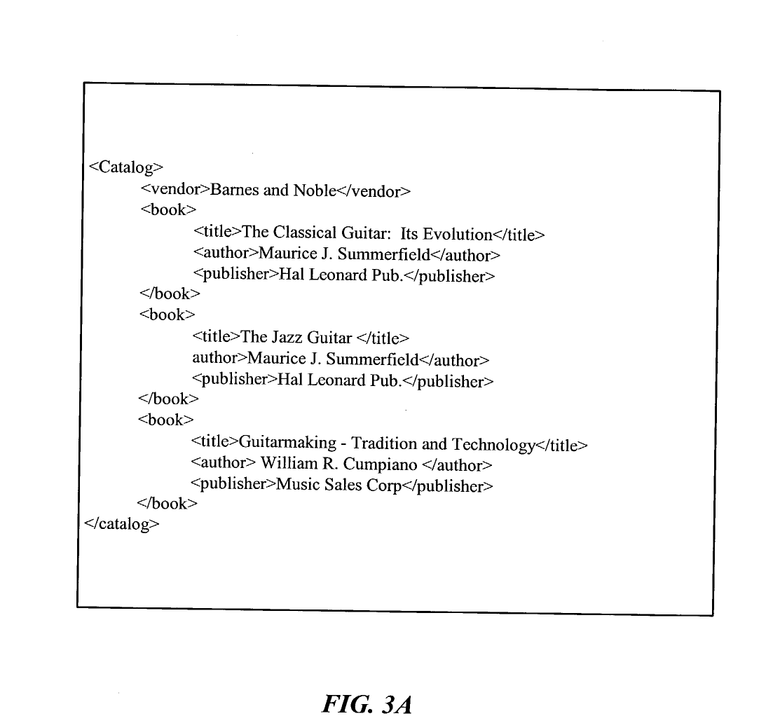

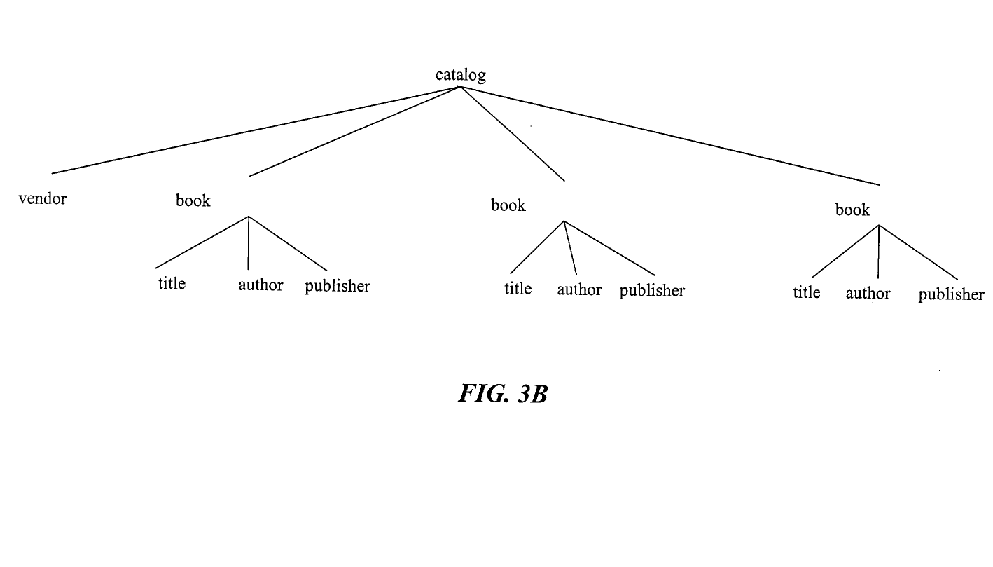

FIG. 3a illustrates an example XML document for use in the searching system of the present invention. The example of FIG. 3a shows entries in a catalog of books from an XML document. The document includes a plurality of tags arranged hierarchically. For example, the highest-level tag for the document is “Catalog.” The second level of the hierarchy of tags includes a tag for “vendor” and tags for “book.” A third level of tags, which includes the tags “title”, “author”, and “publisher”, is provided in the example of FIG. 3a under the path /catalog/book.

The hierarchical tag structure of an XML document may be arranged as a tree structure. FIG. 3b illustrates a tree structure for the XML document of FIG. 3a. As shown in FIG. 3b, the top level node of the tree, catalog, is the top level tag in the document (FIG. 3a). The second level of nodes in the tree structure of FIG. 3b includes the nodes “vendor”, “book”, “book”, and “book.” The nodes “title”, “author”, and “publisher” constitute a third level of nodes in the tree structure underneath the “book” nodes.

As shown in FIG. 3a, each tag has associated free text. For example, the first vendor tag includes the free text “Barnes and Noble.” Also, the free text “The Classical Guitar: Its Evolution” is associated with the first/catalog/book/title tag. Thus, as illustrated by the above example, semi-structured text includes free text and tags associated with the free text.

The search system of the present invention is schema independent. A schema, as used herein, defines one or more structured fields for a document. The structured fields may specify a format for associated data (e.g., integer data or predefined character string), or the structured fields may not specify a format (e.g., free text). In general, the search system receives documents (e.g., XML documents), and processes the documents to permit searching on the structured fields and associated free text. The documents need not have a pre-defined schema. The documents may all possess a different schema. As described below, the unique indices of the search system permit searching on schema independent documents.

A location path is used to traverse the tree to the location of the information. For example, the location path for the title of books in the catalog is:

/catalog/book/title.

The location path descends from the root node through a series of location steps that contain explicitly named XML elements. A series of element names separated by slashes is one of the simplest forms of a location path.

Location paths consist of one or more location steps that identify nodes on the basis of their relationships to the last known location step or context node. For example, the slash that separates a series of element names in a location path indicates that there is a parent/child relationship between the elements on the left and the right sides of the slash.

The slash separator is an abbreviation for the expression child::name, where child is the name of the axis that contains the children of the context node, and name is a string used as the name test to select elements having a matching value. In addition to the child axis, there are additional location axes that may be used to define location steps. Table 1 sets forth one embodiment for location axes and items that they contain.

TABLE 1

| LOCATION AXES | ITEM |
|---|---|
| Ancestor | Includes all nodes above the context |
| | node in the tree. |
| Ancestor-or-self | Includes all nodes above and |
| | including the context node in the node tree. |
| Attribute | Contains all the attributes of the |
| | context node if it is in an element, |
| | otherwise the attribute axis is empty. |
| Child | Includes the nodes in the first |
| | generation below the context node. |
| Descendant | Includes all nodes below the context |
| | node in the node tree. |
| Descendant-or-self | Includes all nodes below and |
| | including the context node in the node tree. |
| Following | Includes all nodes that appear after |
| | the context node in the document order. |
| Following-sibling | Includes all nodes at the same level |
| | as the context node that appear after the |
| | context node in the XML document. |
| Parent | Includes all nodes in the first |
| | generation above the context node. |
| Preceding | Includes all nodes before the |
| | context node in the document order. |
| Preceding-sibling | Includes all nodes at the same level |
| | of the context node that appear before the |
| | of the context node that appear before the |
| | context node in the XML document. |
| Self | Contains the context node. |

In one embodiment, the search system permits the use of wildcards. Using the wildcard character, *, for a node test, all the items in the named axis are selected. For example, the wildcard in the location path below selects all the attributes of the element vendor:

/catalog/vendor/attribute::*

Also, the following functions may be used as the node test to restrict the selection of items in an axis on the basis of node type.

text( ) to select text nodes;

comment( ) to select comment nodes;

processing-instruction(name) to select all XML processing instruction nodes or the processing instruction nodes that match the optional name argument; and

node( ) to select nodes of all types.

In one embodiment, the search system permits the use of predicates to further refine the selection of nodes. A predicate permits a user to restrict the selection of nodes in an axis to those of a particular position or to those that satisfy a Boolean criteria. Predicates may consist of any valid expression in the search system, including functions and free-text query expressions.

In one embodiment, the search system permits the use of abbreviated notation for location paths. Table 2 sets forth one embodiment for abbreviations used to identify location paths.

TABLE 2

| LOCATION | | SPECIAL |
|---|---|---|
| PATH ELEMENT | ABBREVIATION | CONDITIONS |
| self::node( ) | | Equivalent to the |
| | | context node. |
| | | context node. |
| Child:: | / | Child is the default |
| | | axis for location paths. |
| /descendant-or- | // | |
| self::node( )/ | | |
| Parent::node( ) | . . . | |
| Attribute:: | @ | |
| Position( ) | number | Used as a predicate |
| | | expression. |

As shown in FIG. 1, a user submits commands and documents to search system 110. The commands request the search system to execute queries, as well as add and delete documents. In response to a user's query command, the search system 110 accesses information in a repository of documents to identify information relevant to the user's query.

As shown in FIG. 1, the repository includes structured data 120, semi-structured data 130 and unstructured data 140. The search system 110 processes the user's query to locate information regardless of whether the documents comprise structured data, semi-structured data, or unstructured data. This versatile search system permits a user to search all media types. For example, the user may search, with only a single query, numeric data, stored in structured documents, and XML documents stored as semi-structured data. Thus, the search system may be used to identify, using a single query, multiple data types even though the data types constitute different types of data.

In general, a free text search permits the user to identify documents based on a query composed of words and phrases. In one embodiment, a free text query expression consists of terms, phrases enclosed by quotation marks, and Boolean expressions grouped in parentheses, as necessary.

In one embodiment, search system 100 utilizes a unique query language. In general, the unique query language specifies syntax to search semi-structured text. In addition, the unique query language enables the user to specify portions of documents for search as well as specify the format of the results returned. In one embodiment, the unique query language includes an implementation of the W3C XML Path language (“XPath”) enriched with elements from the emerging W3C XML query language (“XQuery”), and augmented with a complete free text query language. The unique query language integrates features from these resources in a single syntax.

In one embodiment, to implement portions of the XQuery language, the search system implements features of the XQuery FLWR expression and element constructors. The FLWR expression provides a way to bind values to one or more variables and to use these variables to construct a result. The FOR, WHERE, and RETURN clauses of the XQuery FLWR expression provide the basic structure for the query language. The FOR clause defines an iteration loop and binds a variable to successive values of an Xpath expression including location paths. The WHERE clause acts as a Boolean filter to control which FOR loop iterations are considered in the evaluation of the RETURN clause. The RETURN clause expression is evaluated on each loop iteration that passes the WHERE filter.

As the search system applies a query to a document, it binds two variables to the meta-information about the document. In one embodiment, the built-in variables comprise:

$xbd:docid for containing the identification number of the document being evaluated; and

$xdb:uri for containing the document's URI of the document being evaluated.

In one embodiment, the search system permits searching with values and retrieving values of any document tags that exist in the database. The document tags are referred to as variables using the following syntax: $xdbtag:tagname. The following query uses a document tag for vendors with catalogs in English:

FOR $c IN/catalog

WHERE $xdbtag:XdbLanguage=“31”

RETURN $c/vendor

In one embodiment, the query language for the search system adds an optional PRESORT clause to the XQuery FLWR expression to specify the sort order of query results. Both ASCENDING and DESCENDING sort orders are supported and may be combined in a single PRESORT expression.

The element constructors permit a user of the search system to control the output format of the query result. The element constructor expressions consist of one or more element specifiers, attribute specifiers, and expressions. The element specifiers delimit the element constructor expression. The attribute specifiers may consist of either a string or an expression enclosed in curly braces. The query expressions for evaluation in an element constructor are enclosed in curly braces.

In one embodiment, the search system 100 operates in two modes: the structured query mode and free text query mode. The structured query mode is used to send queries that use the syntax and functionality of the unique query language, including free text query expressions. The free text query mode permits a user to submit free text query expressions only. In one embodiment, the user submits queries to a server using a “query” command, followed by a transmit data block that contains the query string. One embodiment of the syntax for the query command follows.

{<xdb >

<command>

<query>
<Execute>

<args>

<firstresult>firstresult</firstresult>
<numresults>numresults</ numresults>
<freetext>freetext</freetext>
<disableScoringParams><disableScoringParams>

</disableScoringParams>

<language>language</language>

</args>

</Execute>
</query>

</command>

</xdb>

Table 3 lists the parameters and description of the query command.

TABLE 3

| PARAMETER | DESCRIPTION |
|---|---|
| firstresult | Identifies the first document for |
| | return in the reply block. |
| numresults | Specifies the maximum number of |
| | documents for return by the query. |
| freetext | Indicates whether or not querystring |
| | is a free-text query expression. |
| disableScoringParams | Permits setting custom scoring |
| | parameters for each document type. |
| language | The language of the query and |
| | documents. |

In one embodiment, the sting for the transmit data block is expressed as:

<xdbdata length=“numBytes”>querystring</xdbdata>

wherein, the length parameter specifies the number of bytes in the query string, and the query string contains the query text. Successful commands return the result of the query. The results are returned in XDB data blocks.

In one embodiment, the unique query language supports the construction of free text query expressions using the “+” and the “−” operators. If these expressions are included with the free text query command parameter set to true, then the search system returns the URI, document ID, and, in some embodiments, a score for each matching document in the repository. For example, in free text query mode, the following expression returns scored URIs for documents that contain the word “vacuum”, but do not contain the word “cleaner”:

+vacum −cleaner.

Alternatively, free text queries may be incorporated into structured queries using the “free-text-query ( ) function.” In one embodiment, to combine free text queries with features of a structured query language, the search system provides the free-text-query( ) function. In one embodiment, the free-text-query( ) function includes, as parameters, the identification of a structured field (i.e., a structured field construct) and identification of free text (i.e., a free text construct), as follows:

Free-text-query(structured field construct, free text query construct).

In one embodiment, the identification of a structured field is performed in accordance with the XPath language. For this embodiment, the structured field construct identifies a node set for documents in the repository.

The free-text-query( ) function may be applied to fragments of a document. For example, the following expression selects documents that contain the phrase “Glean Fleeber” in the “title” element, and returns the URI and score for each matching document:

FOR $score IN free-text-query (//title, “Glean Fleeber”)

RETURN <result uri={$xdb:uri}>{$score</result>

The query may return the following result:

<xdbdata length=“50”><result uri=“http://www.glean-fleeber.com/docs/users-guide.xml”>10.693147</result>

</xdbdata>

The query below uses the free-text-query( ) function in the WHERE clause to specify search criteria:

FOR $b IN/catalog/book

WHERE free-text-query($b/description, “+history+classical”)

RETURN $b

In one embodiment, the user sets the parameter of the query command “true” to submit free query expressions directly as query strings in transmit data blocks. For example, the following may be submitted in a transmit data block:

<xdbdata length=“23”>+satellite−television</xdbdata>.

The following Boolean operators are available in free text query search expressions: “OR”, “AND”, “AND NOT”, “AND HAS”, “+”, and “−” For example, the following free text query expression selects documents that contain the phrase “regenerative braking” and either the phrase “hybrid vehicle” or the term “HEV”, or both:

((“hybrid vehicle” OR HEV) AND “regenerative braking)).

The system permits a user to simplify the query using the “+” and “−” Boolean operators. For example, the free text query expression below selects documents that contain the word “satellite”, but not the word “television”:

+satellite−television.

In one embodiment, the unique query language supports standard arithmetic and Boolean operators for the manipulation of expressions. The search system of the present invention includes free text query syntax to provide an additional set of relational operators designed specifically for use in performing searches on the contents of node sets. The following arithmetic operators are included in the unique query language.

TABLE 4

| ARITHMETIC | |
|---|---|
| OPERATOR | FUNCTION |
| + | Addition |
| − | Subtraction |
| * | Multiplication |
| DIV | Division |
| MOD | Remainder of Truncating Division |

The operands of arithmetic operators are interpreted as numbers. In one embodiment, the unique query language includes the Boolean operators: “OR”, “AND”, “=,!=”, “<=,<,>=,>.” In the absence of explicit grouping using parentheses, these Boolean operators are left associative. When a node set is compared to a string or numeric value, the expression is true if the comparison is true for the value of any one member of the node set.

The search system provides the choice to apply a query to a single document or to apply the query to a complete set of documents. To apply a query to a single document, the query specifies the address of the target document in a FOR clause as of a FLWR expression using the document( ) function. The document( ) function takes the URI of the target document as a string parameter, and returns the root node of the document at that address. For example, the query below searches the specific document for titles by Jason Waldron:

FOR $B IN document (http://www.bn.com/book catalog.xml)//book

WHERE $b/author=“Jason Waldron”

RETURN $b/title

This query iterates over all book elements in the document whose URI is “http://www.bn.com/book_catalog.xml”, and returns the matching titles.

In the absence of an explicitly stated target document, the query is implicitly expanded into a query that targets all documents in the repository. For example, the following query does not explicitly include the “document( )” function:

FOR $b IN//book

RETURN $b/title

However, the query implicitly expands the above query to the following expression:

FOR $doc IN document (“*”), $b IN $doc//book

RETURN $b/title

The search engine executes this query as a nested loop. The outer loop iterates over all the documents. For each document in the outer loop, the inner loop iterates over each book element.

In one embodiment, the unique query language provides support for word stemming. For this embodiment, the user may search for all documents containing any “stems” of a particular word. For example, the word “run” would have the following derivations: running, ran, and runs. In one embodiment, to specify a stem, the query term is preceded with the stem prefix. For example, to specify a search to stem the term “play”, the user submits the query:

stem:play.

In response to a query term with a specified stem, the search system identifies all grammatically correct derivations of that word, including different tenses. For the example “play”, the search system searches for all documents containing stem variants of the word “play”, including “playing”, “played”, and “plays.” In one embodiment, the parser converts the input query to all stem variants for selection of those stem variants in the word index. The user may avoid the past tense to identify documents. For the example above, to avoid the past tense, the user may specify: “stem:play-played.”

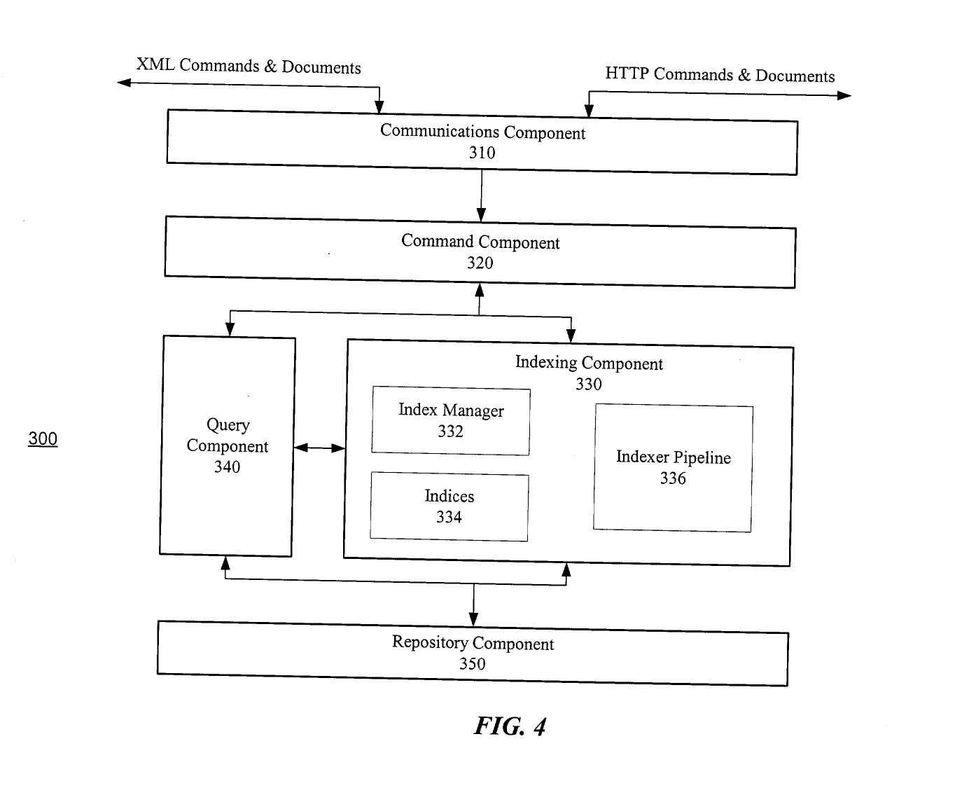

FIG. 4 is a block diagram illustrating one embodiment of the search system of the present invention. Search system 300 receives, as input, documents as the source of information for the search system. As described more fully below, the documents are indexed, in indexing component 330, and stored in repository component 350. A user of search system 300 submits queries to identify and retrieve information regarding the documents (i.e., documents indexed and stored in the repository component).

As shown in FIG. 4, a communications component 310 receives commands and documents. In one embodiment, the communications component 310 receives XML commands and documents as well as HTTP commands and documents. The communications component 310 supports the requisite protocols necessary to process the XML and HTTP commands and documents. The communications component 310 passes the commands and documents to command component 320. If the command is a query, then the command component 320 passes the command to query component 340.

The query component 340 obtains a list of indices from the indexing component 330, and executes the query against those indices. The query component 340 also accesses, as necessary, document information from repository component 350 in response to the query command. If the input to search system 300 is a document, the command component 320 passes the document to the indexing component 330. In general, the indexing component 330 indexes documents, using index manager 332 and index pipeline 336, to generate indices 334. In addition, the documents are input to the repository component 350 for storage.

In one embodiment, the search system 300 includes a relevance ranking component (not shown). In general, the relevance ranking component permits users to relevance rank unstructured, semi-structured and structured text documents identified in a search. A complete description of relevance ranking for unstructured, semi-structured and structured text documents is disclosed in United States Patent Application “Apparatus and Method for Region Sensitive Dynamically Configurable Document Relevance Ranking”, Ser. No.: ______, inventors Douglass Russell Judd, Ram Subbaroyan, and Bruce D. Karsh, filed May 14, 2003, and is expressly incorporated herein by reference.

In one embodiment, the search system of the present invention permits both processing queries as well as entering and deleting documents into the system. In prior search systems, all documents must be entered and indexed prior to processing queries. For these systems, the entire document set must be re-indexed in order to add or delete documents from the repository. The search systems of the present invention are “dynamic” in that the user may execute queries as well as add, delete, and modify documents in the system. As described more fully below, the search system uses multiple indices to support the dynamic search system. The multiple indices are used to both enter new documents into the search system as well as to execute queries.

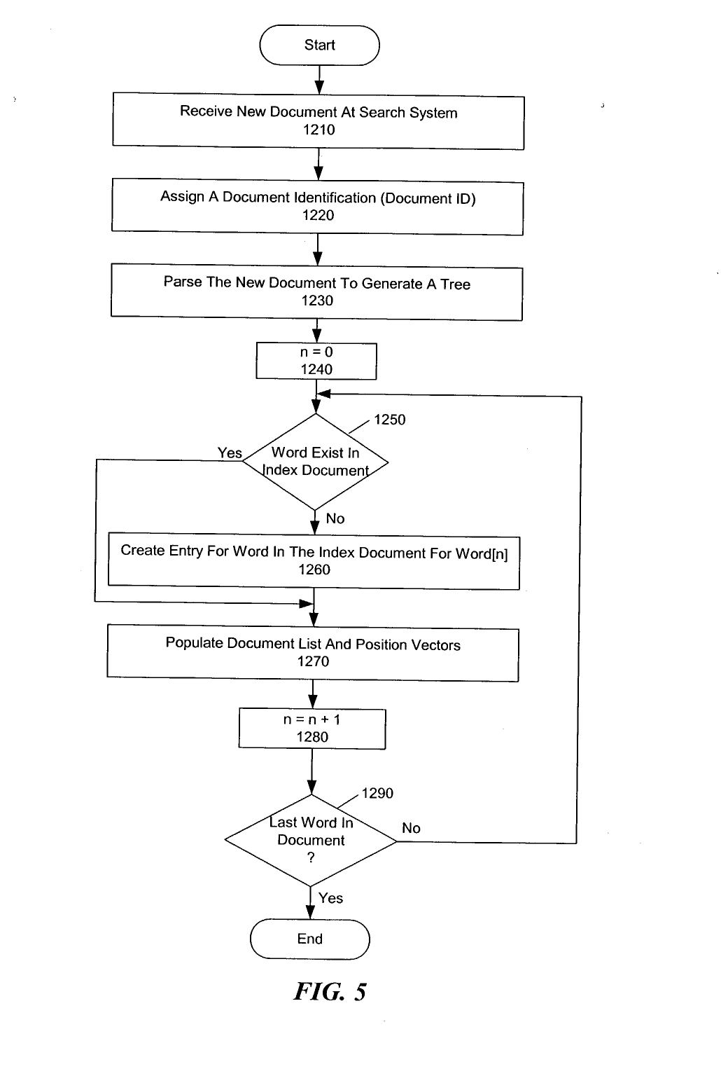

The search system processes new documents input to the search system. FIG. 5 is a flow diagram illustrating one embodiment for processing input documents to the search system. The system receives new documents (block 1210, FIG. 5). Each document is assigned a document identification number “document ID” (block 1220, FIG. 5). The new documents are parsed to generate a tree (block 1230, FIG. 5). In general, the input document, formatted in XML, is converted to a hierarchical tree structure. In one embodiment, the search system utilizes a document object model (“DOM”) parser. The parsing process includes the function of determining word breaks within the new document. As described fully below, the indices store position information for words within a document. In one embodiment, the search system utilizes specialized software to determine word boundaries, particularly for certain non-English languages (e.g., Chinese characters).

For each new document entered in the system, the process creates an index document. In general, to create the index document, the search system traverses the nodes of the tree (i.e., the tree generated by the DOM parser). For each node of the tree, the search system enters the word in the word index. From this, the search system builds a word list, document list, and position vector. To create the index document, each word from the new document is entered. This process is illustrated in FIG. 5 through the initialization of the integer variable, “n”, to zero. The variable n signifies a pointer to identify the current word being processed. If the current word (word[n]) does not exist in the index document, then the process creates an entry for the word (blocks 1250 and 1260, FIG. 5). Once a word entry has been created for the current word, the process populates information for that word entry (block 1270, FIG. 5). Alternatively, if the word already exists in the index document, then the process populates information for the current word[n] (blocks 1250 and 1270, FIG. 5). In one embodiment, the index document includes a document list, for each word entry, and a position vector for each document in the document list. The contents of the word list, document list and position vectors are described more fully below.

The current word is incremented (block 1280, FIG. 5), and if the current word is not the last word in the document, then the next word in the document is entered into the index document (blocks 1290, 1250, 1260, 1270, and 1280, FIG. 5). The process to generate an index document is complete after the last word in the document has been entered into the index document (block 1290, FIG. 5).

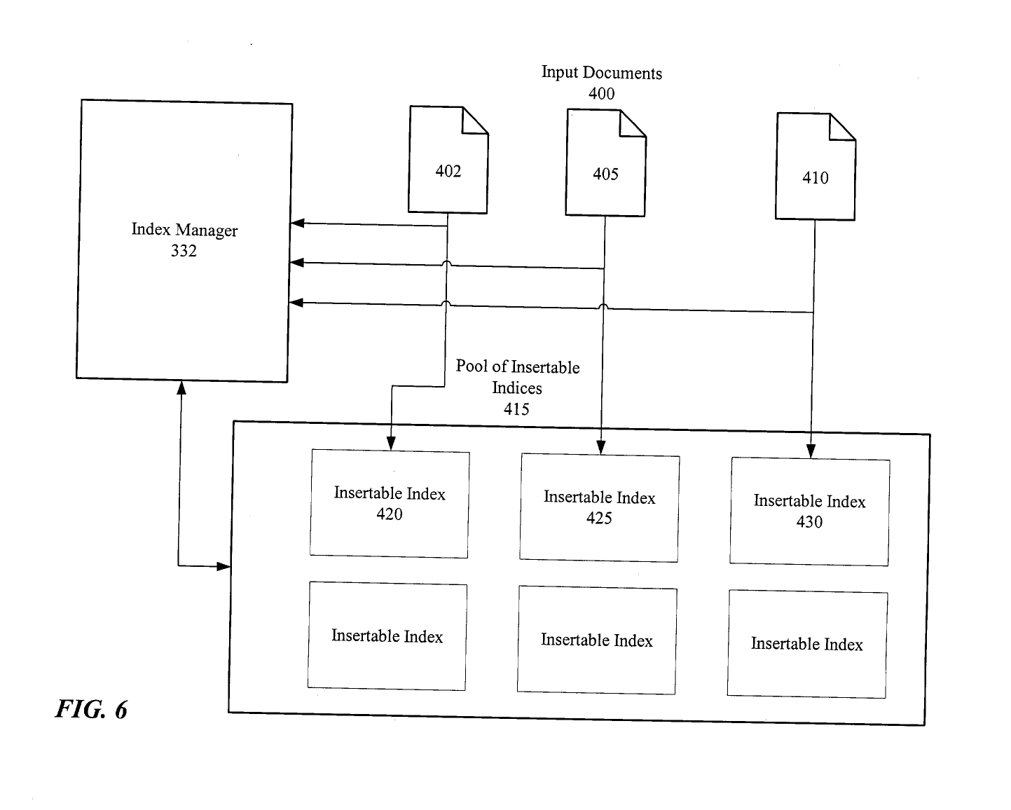

In one embodiment, the process to generate new documents is performed in the index pipeline 336 (FIG. 4). The index pipeline 336 passes one or more index documents to the index manager 332. The index manager 332 performs a process to merge the index documents to a pool of insertable indices (See FIG. 6).

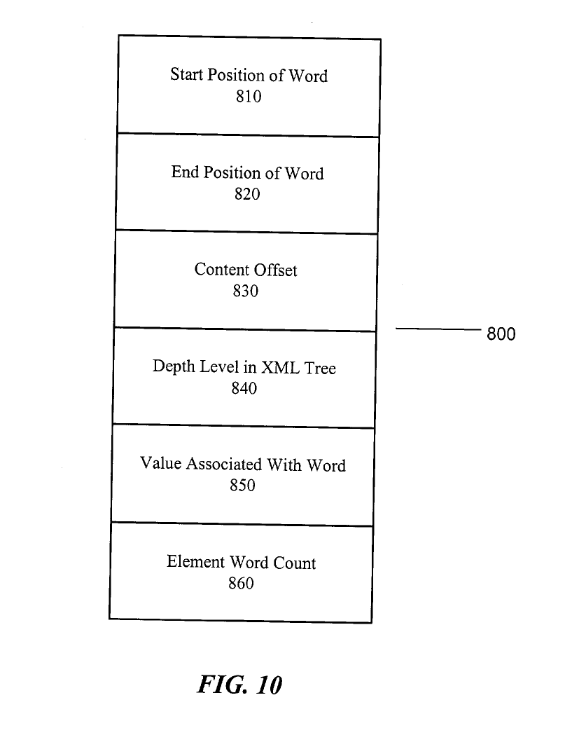

In one embodiment, processing for documents input to the search system includes additional functions. If the word entry is an XML tag, and the associated value is a number, then the process converts the number representation in the document to a floating-point representation for storage in the position vector (entry 800, FIG. 10). Also, the process specifies XML attributes, identified in the tree structure, for inclusion into the index document.

In one embodiment, the search system uses persistent indices and incremental indices. As used herein, “persistent indices” are those indices that the system stores on a permanent storage medium (e.g., a hard disk drive). The search system stores incremental indices in random access memory (“RAM”) of the computer (e.g., server). The index manager 332 (FIG. 4) executes a merger process to combine one or more indices.

In one embodiment, the indexing component 330 (FIG. 4) uses a pool of insertable indices to enter documents into the system. FIG. 6 is a block diagram illustrating one embodiment for inserting index documents into the search system. In general, the index manager 332 manages a pool of insertable indices 415 for input documents. Specifically, index manager 332 selects an insertable index from the pool of insertable indices 415 to index a single document. Only one document is inserted into an insertable index at a time. The insertable indices have a predetermined maximum size. When an insertable index has reached its maximum size, it is no longer available within the pool of insertable indices. In one embodiment, the number of document indices measures the index size. As shown in FIG. 6, index manager 332 selects an insertable index for each individual document inserted in the search system. For this example, index manager 332 selects: insertable index 420 for document 402, insertable index 425 for document 405, and insertable index 430 for document 410.

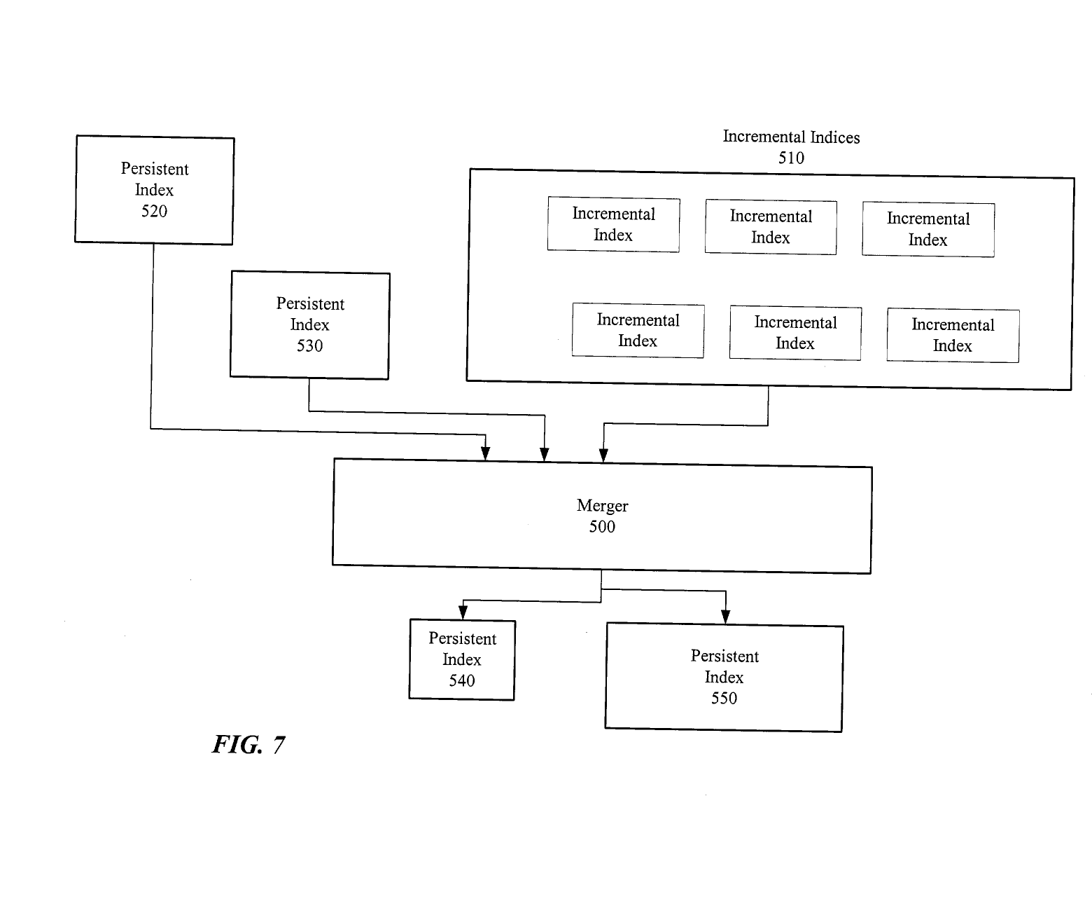

In one embodiment, the index manager executes a merge process when a threshold number of insertable indices are full. FIG. 7 is a block diagram illustrating one embodiment for the merge process. For the merge process, a merger 500 combines incremental indices to create one or more persistent indices. For the example of FIG. 7, a plurality of incremental indices 510 are combined with one or more persistent indices (520 and 530), to generate one or more persistent indices (540 and 550). In one embodiment, the search system puts a limit on the size of a persistent index. Thus, the merge process may generate more than one persistent index. Also, it is inefficient to merge a large index with a small index. Under this scenario, the merger maximizes efficiency of the process by generating, if necessary, multiple persistent indices. In another embodiment, the index manager places a limit on the total number of indices. If the maximum number is exceeded, then the merge operation is triggered.

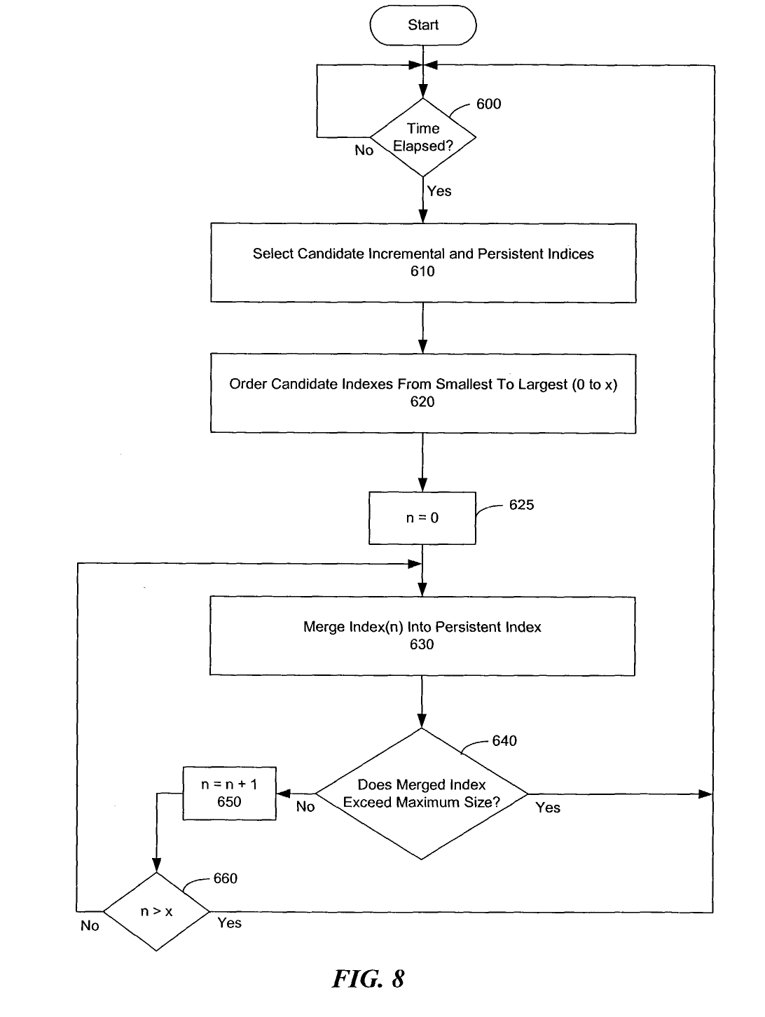

FIG. 8 is a flow diagram illustrating one embodiment of a merge process to combine indices in the search system. In one embodiment, the index manager 332 executes the merge process after expiration of a predetermined amount of time (e.g., every 15 seconds after completion of the previous merge operation). If the predetermined amount of time has elapsed, then the merge process selects candidate incremental and persistent indices (blocks 600 and 610). When selecting index candidates to merge, the merger considers all persistent indices and filled incremental indices. The candidate indices are ordered starting from the smallest size index to the largest size index as shown in block 620 (e.g., ordering Index₀ to Indexₓ such that Index₀ is the smallest and Indexₓ is the largest). Using this order, the merger selects indices until the size of the generated new index exceeds a maximum size. This process is illustrated in FIG. 8 by initializing the pointer to the index_{[n]} to 0 (block 625). Index₀ is merged into a persistent index (block 630). The merge process then determines whether the new merged index exceeds the maximum size permitted (block 640). If it does not, then the process selects the next candidate index, and determines whether there are additional candidate indices to merge (blocks 650 and 660). If there are more candidate indices to merge, then the process repeats steps 630, 640, 650 and 660. Alternatively, if the last candidate index has been merged or if the merged index exceeds the maximum size, the process jumps back to operation 600 to wait the predetermined amount of time prior to executing another merge process.

The search system supports dynamically deleting documents for consideration during query execution. In one embodiment, each index (incremental and persistent) has a “deleted document ID list.” To delete a document from the system, the user transmits a command that identifies the document for deletion. In response, the system identifies the index for the corresponding document. Specifically, the system searches the document list for an index to identify that document from its document ID. Once the index for that document has been located, the system enters, in the deleted document ID list, the document ID. When the system processes queries, the system ignores documents listed on the deleted document ID list.

In general, the index manager operates in two states: allow deletions or insertions. In one embodiment, the index manager prevents a delete operation from occurring during query execution. This way, documents are not deleted during query execution. This prevents indeterminate results from query execution. As described more fully below, the index manager has knowledge that a query is being executed because it passes an index list to query execution. Upon completion of the query execution, the query component (340) returns the index list back to the indexing component.

The system also performs successful delete operations during merge operations. To delete a document during a merge operation, the merger, after completing the merge, traverses the deleted document ID list from the indices that were merged, compares document IDs on the deleted document ID list of the merged indices to documents in the new merged set, and adds the deleted document IDs for the documents, identified in the new merged document set, to the document ID list for the new merged index. During a subsequent merge, the merger drops out any document on the deleted document ID list if that document is no longer identified in the new merged index. Thus, the documents on the deleted document ID list are garbage collected during the next merge operation.

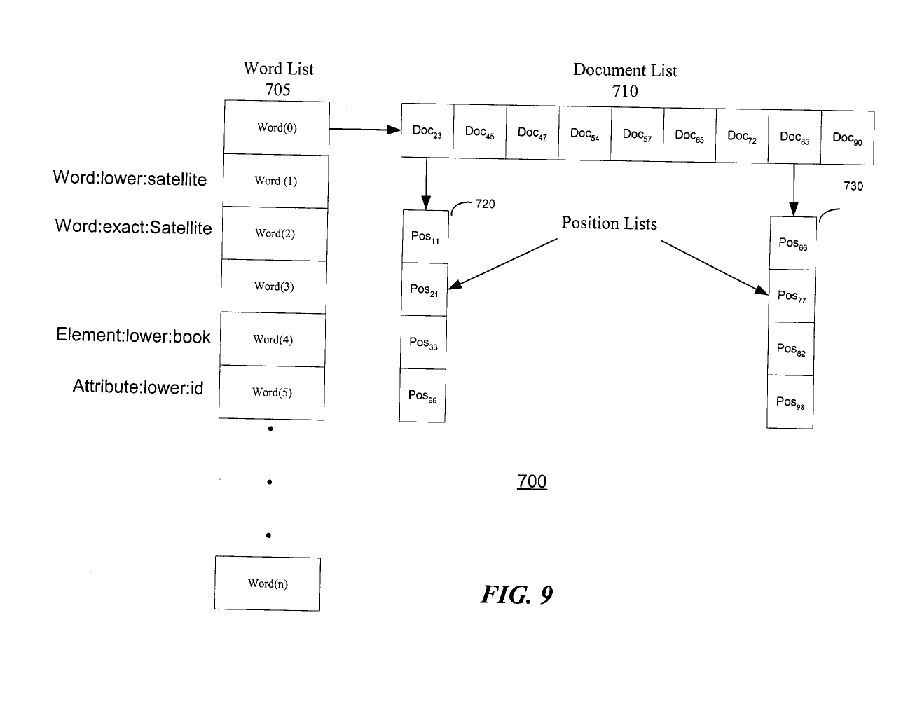

In general, the indices 334 (FIG. 4) contain information to identify documents, words in documents, positions of the words in documents, and additional information to conduct free text query searches within specified sections of the document. FIG. 9 is a block diagram illustrating one embodiment for an index of the search system. For this embodiment, an index includes a word list, a plurality of document lists, one for each word list, and a plurality of position vectors, one for each entry in the document list. The word list identifies each word contained in all documents represented by that index. For example, if five documents are represented by index 700, then word list 705 identifies every word in all five documents. In one embodiment, the word list stores, for a corresponding word, a value derived from a “metaword.” Specifically, an MD5 hash is executed on the metaword. The metaword is formed using the word, element name, etc. In one embodiment, the metaword has the following general format:

<type>:<case>:<word>

The possible values for <type> are set forth in Table 5.

TABLE 5

| Type | Description |
|---|---|
| Word | regular |
| Elem | Element names |
| Attr | Attribute names |
| Pi | Processing instruction |
| Pival | Processing instruction value words |
| comment | Comment words |

The possible values for <case> are set forth in Table 6.

TABLE 6

| Case | Description |
|---|---|
| Exact | The word has at least one uppercase |
| | character. |
| Lower | The word has all lowercase |
| | characters. |

The <word> portion is the word itself. The following is an example snippet of XML:

<message type=foo>

Hello, world!

</message>

For this example, the following set of metawords are created and inserted in the word list: elem:lower:message, attr:lower:type, word:exact:Hello, and word:lower:world.

In one embodiment, the word list of an index stores additional information about the word. In general, the additional information permits the search system to associate free text with structured fields (e.g., XPath nodes). As shown in FIG. 9, a type for the word is stored. For example, if the word extracted from the document is text, the corresponding entry in the word lists identifies “Word” (e.g., both “satellite” and “Satellite” are words extracted from a document). This permits the search system to differentiate between structured field designators and free text. The word list also identifies elements and attributes from an XML document. For the example in FIG. 9, the value stored in Word₄ represents an element defined in an XML schema, and the value stored in Word₅ represents an attribute defined in an XML schema. In one embodiment, data stored in the word list of an index also identifies whether the word is represented in lower case or whether the word is represented exactly as it appears in the document. For example, the word “Satellite” may appear capitalized in the document. Thus, word index stores, as Word₂, the exact representation of the capitalized word “Satellite.” In addition, word list 705 stores, for the word satellite, the lower case representation of the word. In this way, the index supports case insensitive searches as well as case sensitive searches.

Each entry in a word list has a corresponding document list. The document list identifies all documents for which the corresponding word appears. For example index 700 in FIG. 9, word₍₀₎ has a document list 710. The document list 710 identifies each document, by its document ID, for which Word₍₀₎ appears (e.g., documents 23, 45, 47, 54, 57, 65, 72, 85, and 90).

Each document identified in a document list has a corresponding position vector. For the example index 700 in FIG. 9, document 23 of document list 710 has position vector 720, and document 85 has position vector 730. In general, a position vector identifies every position the corresponding word appears in the corresponding document. For example, words appears in positions 11, 21, 33, and 99 in document 23. Also, word₀ appears in positions 66, 77, 82 and 98 in document 85. The position vectors permit the search system to execute queries that specify the position distance between words in a document. For example, a query may request identification of documents containing word₀ within five word positions of word₃. For this example, the search system utilizes the position vectors from the respective word entries to determine whether word₀ appears within five words of word₅.

In one embodiment, the position vectors include information in addition to the position of the word within a document. FIG. 10 is a block diagram illustrating one embodiment for information contained in a position vector. A position vector stores information for a single word contained in a corresponding document. The position vector 800 includes data to identify: the start position of the word in the document (810), the end position of the word in the document (820), the offset to the content (830), the depth level of the word within an XML schema (840), potentially a value associated with the word (850), and an element word count (860).

The information to identify an offset to the content (830, FIG. 10) allows the query system to identify the start of free text to a structured field. For example, a document schema may specify a “name” structured field with the free text “Jim Smith.” For this example, the information to identify an offset to the content (830, FIG. 10) identifies the starting word position for “Jim” for the “name” structured field. If the search system receives a query (e.g., free text query function) to identify “Jim Smith” within the structured field “name”, then the search system determines, solely from the index, whether the free text “Jim Smith” is associated with the “name” field. Specifically, for this example, the search system determines, from the information to identify an offset to the content (830, FIG. 10), that the word “Jim” is the start of the free text associated with the “name” field. Also, from the position vector, the search system determines that the word “Smith” is adjacent to the word “Jim.” Accordingly, the information to identify an offset to the content (830, FIG. 10) may be used to perform searches on free text associated with a structured field using the index.

The information to identify the depth level of the word within an XML schema (840, FIG. 10) allows the query system to identify structured fields or nodes in a document schema. For example, the structured fields of a document may be organized in a hierarchy of nodes. The information to identify the depth level of the word within an XML schema (840, FIG. 10) permits the system to identify node sets of an XML schema specified in a query. For example, a document may comprise an XML schema as illustrated in FIGS. 3a and 3b. For this example, the catalog node is specified as level 1, and the vendor and three book nodes are specified as level 2. A user may specify a query to identify all nodes with the path of “/catalog/book.” For this example query and schema, the search system determines from the index that the three books, identified as level two nodes underneath the level 1 node “catalog”, satisfy the search criteria. Consequently, the information to identify the depth level of the word within an XML schema (840, FIG. 10) permits the search system to identify node sets from the index from a hierarchy of nodes.

The value associated with the word (850, FIG. 10) allows the search system to conduct range queries. For example, an attribute or element in an XML schema may have an associated value (e.g., book ID=49). This value may be stored in the position vector (850, FIG. 10). This way, the search system does not need to access a document in the repository for query execution to extract the corresponding value associated with the word. In one embodiment, the search system stores a floating point value in the index. For example, the structured field “/age”, may include a value, such as “29.” For this example schema, a user may submit a query that requests all documents with an age field that has a value between 25 and 35. Because the index stores an actual value for the “age” structured field, the search system may conduct a range query directly from the index.

In one embodiment, the position vector 800 includes an element word count (860, FIG. 10). The element word count specifies the actual number of words for an associated element (i.e., the actual word count excludes the mark-up words). For example, a document may comprise an XML schema as illustrated in FIGS. 3a and 3b. A portion of the XML schema follows.

<book>

<title>The Jazz Guitar</title>
<author>Maurice J. Summerfield</author>
<publisher>Hal Leonard Pub.</publisher>

</book>

For this example, the word count for the entry, “elem:lower:book”, is equal to eleven (11), even though the entire count, including mark-up words, from the starting position to the ending position is equal to fourteen (14).

In one embodiment, the search system stores “iterators” within the index structure. In general, an iterator identifies a position in the index structure for both incremental and persistent indices. The actual value of an iterator is based on the type of index (i.e., persistent or incremental). For each word in the word list, a word list iterator identifies a document list iterator. In turn, document list iterators provide references to position vectors.

In one embodiment, the iterators for incremental indices are references to STL maps. The MD5 value is a subscript into the STL map. The STL map returns a structure that contains an STL vector. For a persistent index, the iterator provides an offset to the location of a file on persistent storage for the corresponding word, document list, or position vector.

The search system of the present invention performs processes to recover from a session that is not properly terminated (e.g., computer crashes). In general, when a document is received at the communications module for input to the search system, the document is compiled into an index document, for the indexing system, and a compiled document for the repository. In one embodiment, the search system inserts multiple compiled documents onto the permanent storage medium at the same time. This increases efficiencies when accessing a hard disk drive. The search system responds to the user's command to enter a document into the system only when the write operation has occurred in the hard disk drive. Thus, the system only confirms entry of a document when the compiled document has been stored in the repository.

If the computer crashes at any time after the user has received confirmation that the document has been entered into the system, the compiled document has already been safely stored in the permanent storage medium. However, the index for the corresponding document may have been stored in an incremental index (i.e., in RAM). Under this scenario, if the computer crashes, the incremental index is lost.

In order to recover an index for a document stored in the repository, the search system executes a recovery process at startup. First, the search system (index manager) obtains a list of document IDs from the repository. Then, the index manager parses all persistent indices to obtain all document identifications. If the document is identified in both the repository document ID list and the persistent index document ID list, then the document is safely identified in the search system. Alternatively, if the document is identified in the repository but not identified in a persistent index, then presumably the system crashed before an incremental index merged into a persistent index. Under this scenario, the index manager fetches the document from the repository component, and indexes the document. If a document is identified in an index but not identified in the repository, then the search system deletes the document from the index (i.e., the system synchronizes to the repository).

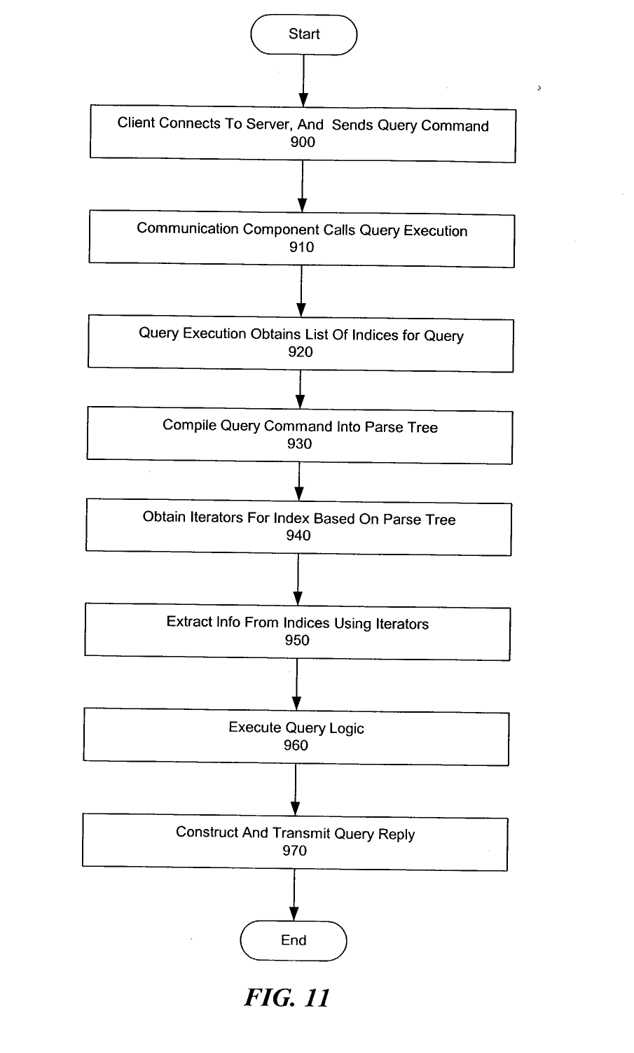

FIG. 11 is a flow diagram illustrating one embodiment for processing queries in the search system. To initiate the process, the client connects to the server (the server that operates the search system), and sends a query command to the server (block 900). In response to the query command at the communications component, the communications component calls the query execution component (block 910). The query execution component obtains a list of all active indices from the index manager to execute the query (block 920). The query command is then compiled into a parse tree (block 930). In one embodiment, the search system utilizes the following XQuery parse node types: Arithmetic PLUS, Arithmetic MINUS, Arithmetic DIVIDE, Arithmetic MULTIPLY, Arithmetic MODULO, Negate, Boolean OR, Boolean AND, Constant Numeric, Constant String, Constant Boolean, Constant Empty Node Set, Element Constructor, Equality EQUAL, Equality NOT EQUAL, Function, Location Path, Relational LESS THAN, Relational LESS THAN OR EQUAL, Relational GREATER THAN, Relational GREATER THAN OR EQUAL, Set Op UNION, Tag, and Variable. The search system utilizes the following free text parse node types: Accrue and Phrase or Word.

In one embodiment, the parser for the query is developed using well-known tools, such as LEX and YCC. The LEX tool is used to develop a parser that identifies pre-defined tokens. Thus, the parser analyzes character string queries input to the system to identify pre-defined tokens. The YACC tool is used to specify grammar rules for the parser. For example, the YACC tool is used to specify parsing of the FLWR expression used to specify queries.

In one embodiment, the query command is an XML document. The query itself is text wrapped in an XML document. The parse tree is optimized. The query execution component executes the query by traversing the compiled parse tree. Specifically, the query execution component obtains iterators for indices identified by the parse tree (block 940). The iterators are used to extract the relative information from the indices (i.e., information relevant to the query command). Based on this information, the query execution command executes the logic specified in the query command (block 960). From this, the query execution component constructs a reply (block 970). The reply may be based solely on information extracted from the indices, or the reply may be based on excerpts extracted from the documents in the repository.

During query execution, the index manager provides a list to the query execution component of all active indices in the system. From this, the index manager enters the state to halt all deletions and insertions of the documents in the search system. When the index manager receives the index list returned from the query execution component, the deletions and insertions of documents may resume.

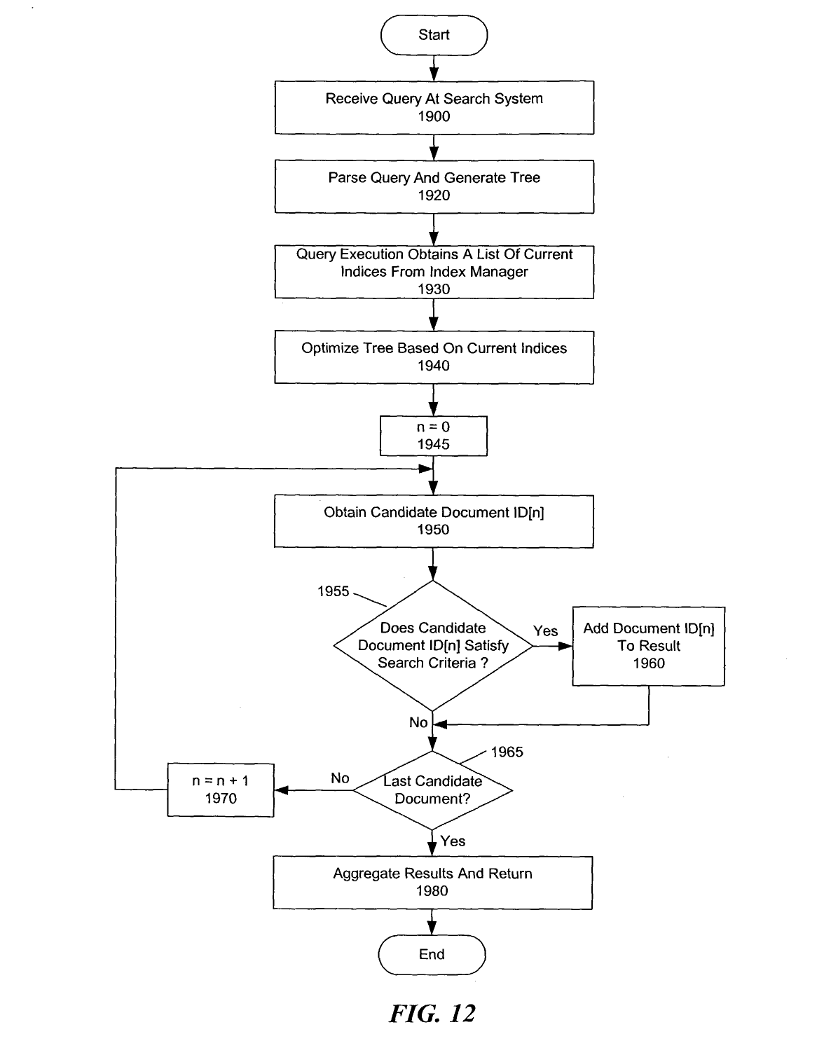

FIG. 12 is another flow diagram illustrating one embodiment for executing a query in the search system of the present invention. The process is initiated when the search system receives a query (block 1900, FIG. 12). The query is parsed into a tree (block 1920, FIG. 12). The example query “I/name=Joe Blow” is parsed into a tree that consists of an equality node at the highest level followed by a location path node (i.e., //name) and a constant string node (i.e., “Joe Blow”).

The query execution (block 340, FIG. 4) obtains a list of current or active indices from the index manager (block 1930, FIG. 12). The active list of indices contains information for the repository of documents used for that query.

The process optimizes the query tree based on the current indices (block 1940, FIG. 12). In general, the process optimizes the query tree by eliminating, if possible, sub-trees in the query tree. Specifically, the process runs through the various nodes of the query tree, and determines whether any sub-tree will evaluate to a predetermined condition. For example, if the query requires a certain word and that word is not in the index, then regardless of the additional constraints that query will evaluate to zero.

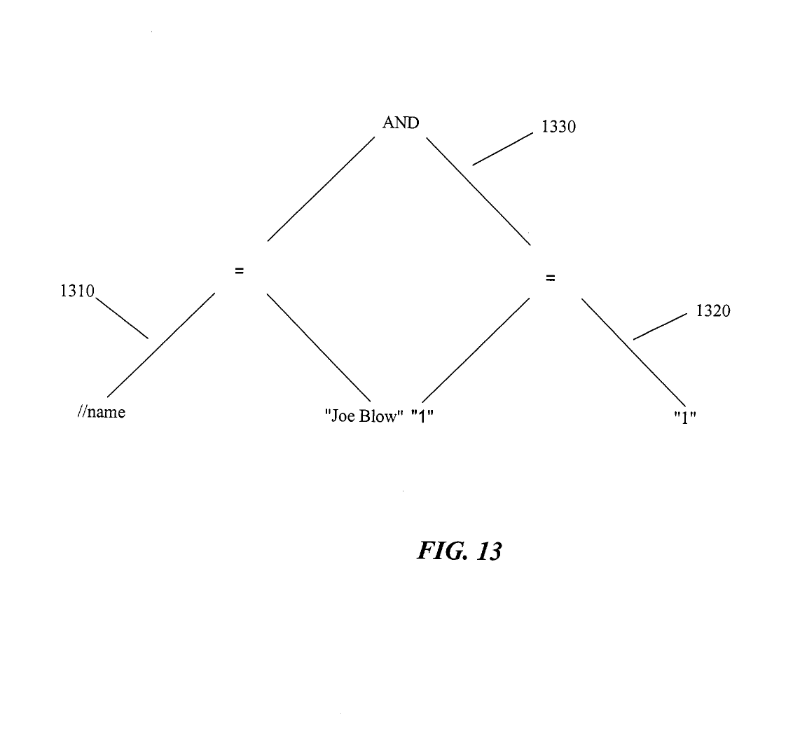

FIG. 13 illustrates a query tree for the example query “I/name=Joe Blow AND 1=1.” The example query includes two conditions: 1) identify, within the element “//name”, the string “Joe Blow”, and evaluate the condition “1=1.” The search system determines whether the string “Joe Blow” and the element “//name” are located in an index. If they exist, then the sub-tree labeled 1310 in FIG. 13 cannot be optimized (i.e., there is a possibility that the condition “//name=“Joe Blow” will be met). The sub tree and 1320 is then evaluated. Because the condition “1=1” is always true, sub-tree 1320 is eliminated from further processing. In addition, sub-tree 1330 is also eliminated because the AND expression is now entirely dependent upon the condition of sub-tree 1330.

The query process identifies candidate documents (i.e., documents that contain words, elements, attributes specified in the query) and evaluates those documents against the query tree. A variable, such as n, is used to identify the candidate document. To begin the process, the variable, n, is initialized to zero (block 1945, FIG. 12.). With the variable n set to zero, the process obtains the first candidate document, identified as candidate document ID[n] (block 1950, FIG. 12). To accomplish this, the query component identifies the first document that contains the requisite words. For the example query “//name=“Joe Blow”, the query component identifies, from the indices, a document that includes the string “Joe Blow” and the element “//name.” The query component determines whether the candidate document satisfies the search criteria in the optimized tree (block 1955, FIG. 12). For the above example, the query component determines whether the string “Joe Blow” is associated with the element “//name.” If the candidate document ID[n] does satisfy the search criteria, then the document ID[n] is added to the result (block 1960, FIG. 12). If the candidate document is not the last candidate document, then the query component proceeds to the next candidate document (blocks 1965 and 1970, FIG. 12). The steps of obtaining the candidate document, determining whether the candidate document evaluates to the query tree, and if so, adding the candidate document to the result, are repeated for all candidate documents. The query component then aggregates the results from all candidate documents, and returns those results to the user (block 1980, FIG. 12). Also, the query component returns the list of indices to the index manager.

In one embodiment, the query execution component utilizes five methods to execute the query: load index, seek to first document ID, seek to next document ID, optimize tree, and evaluate query tree against document. To identify candidate documents, the query component identifies all the iterators for indices that include the corresponding nodes. For example, the query component identifies iterators to the element entry “//name” and to the words “Joe” and “Blow.” Then, using the iterators, the query component seeks the first document that has overlapping word entries for the input query. For example, the process seeks a document that includes both the element “//name”, the word “Joe”, and the word “Blow.” In one embodiment, the evaluation process returns, as types of results, true/false, a set of nodes (XML fragments), numeric, string, and score.

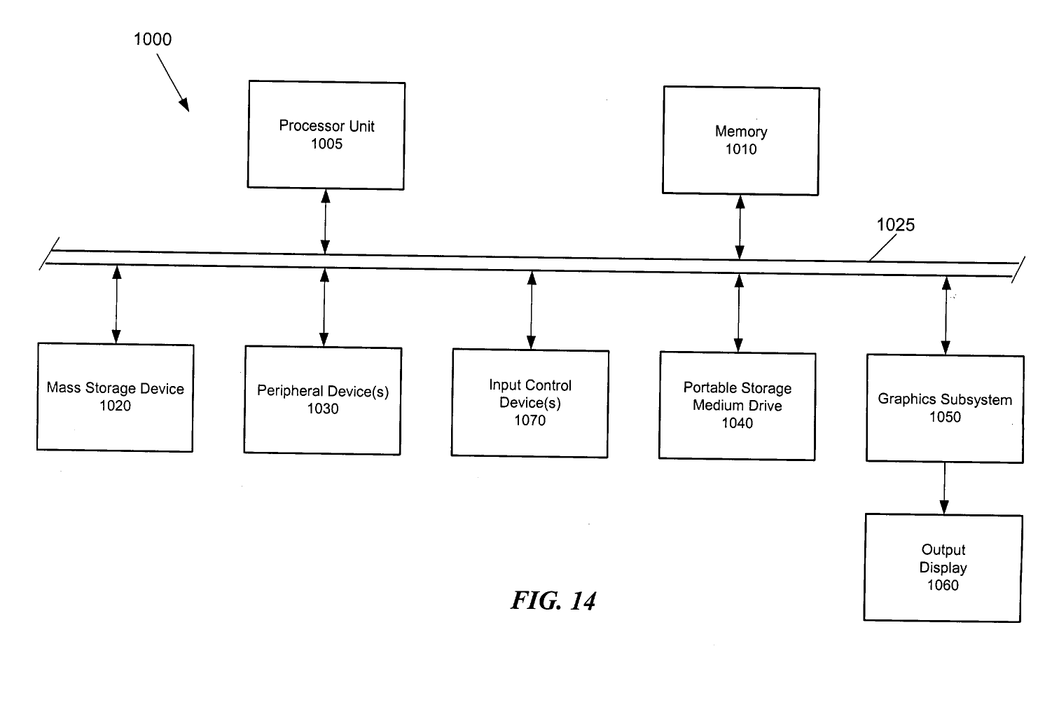

FIG. 14 illustrates a high-level block diagram of a general-purpose computer system that implements the search system of the present invention. A computer system 1000 contains a processor unit 1005, main memory 1010, and an interconnect bus 1025. The processor unit 1005 may contain a single microprocessor, or may contain a plurality of microprocessors for configuring the computer system 1000 as a multi-processor system. The main memory 1010 stores, in part, instructions and data for execution by the processor unit 1005. If the search system of the present invention is partially implemented in software, the main memory 1010 stores the executable code when in operation. The main memory 1010 may include banks of dynamic random access memory (DRAM) as well as high-speed cache memory.

The computer system 1000 further includes a mass storage device 1020, peripheral device(s) 1030, portable storage medium drive(s) 1040, input control device(s) 1070, a graphics subsystem 1050, and an output display 1060. For purposes of simplicity, all components in the computer system 1000 are shown in FIG. 14 as being connected via the bus 1025. However, the computer system 1000 may be connected through one or more data transport means. For example, the processor unit 1005 and the main memory 1010 may be connected via a local microprocessor bus, and the mass storage device 1020, peripheral device(s) 1030, portable storage medium drive(s) 1040, graphics subsystem 1050 may be connected via one or more input/output (I/O) busses. The mass storage device 1020, which may be implemented with a magnetic disk drive or an optical disk drive, is a non-volatile storage device for storing data and instructions for use by the processor unit 1005. In the software embodiment, the mass storage device 1020 stores the search system software for loading to the main memory 1010.

The portable storage medium drive 1040 operates in conjunction with a portable non-volatile storage medium, such as a floppy disk or a compact disc read only memory (CD-ROM), to input and output data and code to and from the computer system 1000. In one embodiment, the search system software is stored on such a portable medium, and is input to the computer system 1000 via the portable storage medium drive 1040. The peripheral device(s) 1030 may include any type of computer support device, such as an input/output (I/O) interface, to add additional functionality to the computer system 1000. For example, the peripheral device(s) 1030 may include a network interface card for interfacing the computer system 1000 to a network.

The input control device(s) 1070 provide a portion of the user interface for a user of the computer system 1000. The input control device(s) 1070 may include an alphanumeric keypad for inputting alphanumeric and other key information, a cursor control device, such as a mouse, a trackball, stylus, or cursor direction keys. In order to display textual and graphical information, the computer system 1000 contains the graphics subsystem 1050 and the output display 1060. The output display 1060 may include a cathode ray tube (CRT) display or liquid crystal display (LCD). The graphics subsystem 1050 receives textual and graphical information, and processes the information for output to the output display 1060. The components contained in the computer system 1000 are those typically found in general purpose computer systems, and in fact, these components are intended to represent a broad category of such computer components that are well known in the art.

The search system may be implemented in either hardware or software. For the software implementation, the search system is software that includes a plurality of computer executable instructions for implementation on a general purpose computer system. Prior to loading into a general-purpose computer system, the search system software may reside as encoded information on a computer readable medium, such as a magnetic floppy disk, magnetic tape, and compact disc read only memory (CD-ROM). In one hardware implementation, the search system may comprise a dedicated processor including processor instructions for performing the functions described herein. Circuits may also be developed to perform the functions described herein.

Although the present invention has been described in terms of specific exemplary embodiments, it will be appreciated that various modifications and alterations might be made by those skilled in the art without departing from the spirit and scope of the invention.

What is claimed is:

1. A method for searching for documents, comprising:
storing a repository of documents, said documents comprising text organized into a plurality of sections;
receiving a query with at least one specified section and at least one free text query construct for text within said specified section, said free text query construct specifying at least one free text search condition;
processing said query to identify said specified section in a group of documents; and
evaluating said free text query construct for said text within said group of documents to determine whether said free text search condition is met.

2. The method of claim 1, wherein:
storing comprises storing documents with corresponding nodes and text associated with said nodes;
receiving comprises receiving a query comprising a node construct for specifying at least one node and said free text query construct; and
processing comprises identifying nodes within said repository of documents that correspond to said node construct.

3. The method of claim 2, wherein:
receiving comprises receiving a location path to identify a node set.

4. The method of claim 1, further comprising returning a document section if said free text search condition is met.

5. The method of claim 1, wherein:
receiving comprises receiving semi-structured documents, said semi-structured documents comprising a plurality of fields with associated data, and at least a portion of said semi-structured documents comprising unstructured free text.

6. The method of claim 1, wherein:
receiving includes receiving information for a plurality of documents, said documents comprising a plurality of structured fields and free text associated with said structured fields, and said documents comprise a plurality of different schemas that define formats for sections of said documents; and
generating an index for said documents, said index for identifying words in said documents and said index comprising information to associate said free text to said structured fields for documents that comprise different schemas.

7. The method of claim 6, wherein:
generating includes generating an offset between said free text and corresponding structured fields.

8. The method of claim 6, wherein:
generating includes generating a start position and an end position to define free text associated with a structured field.

9. The method of claim 6, wherein:
generating includes generating a word count that specifies a number of words associated with a structured field.

10. The method of claim 6, wherein:
receiving includes storing documents with structured fields organized in one or more nodes arranged hierarchically; and
generating includes associating said free text to said structured fields via depth level information for a word corresponding to a level of said word in said hierarchy.

11. A computer readable media, comprising:
a repository of documents with text organized into a plurality of sections; and
executable instructions to
process a query with at least one specified section and at least one free text query construct for text within said specified section, said free text query construct specifying at least one free text search condition;
process said query to identify said specified section in a group of documents; and
evaluate said free text query construct for said text within said group of documents to determine whether said free text search condition is met.

12. The computer readable medium of claim 11,
wherein said repository includes:
documents with corresponding nodes and text associated with said nodes; and wherein said executable instructions include instructions to:
receive a query comprising a node construct for specifying at least one node and said free text query construct; and
identify nodes within said repository of documents that correspond to said node construct.

13. The computer readable medium of claim 12, wherein said executable instructions include instructions to:
receive a location path to identify a node set.

14. The computer readable medium of claim 11, further comprising executable instructions to return a document section if said free text search condition is met.

15. The computer readable medium of claim 11, wherein said repository includes:
semi-structured documents comprising a plurality of fields with associated data, and at least a portion of said semi-structured documents comprising unstructured free text.

16. The computer readable medium of claim 11,
wherein said repository includes:
documents comprising a plurality of structured fields and free text associated with said structured fields, and said documents comprise a plurality of different schemas that define a format for sections of said documents; and
wherein said executable instructions include instructions to
generate an index for said documents, said index for identifying words in said documents and said index comprising information to associate said free text to said structured fields for documents that comprise different schemas.

17. The computer readable medium of claim 16, wherein said executable instructions include instructions to:
generate an offset between said free text and corresponding structured fields.

18. The computer readable medium of claim 16, wherein said executable instructions include instructions to:
generate a start position and an end position to define free text associated with a structured field.

19. The computer readable medium of claim 16, wherein said executable instructions include instructions to:
generate a word count that specifies a number of words associated with a structured field.

20. The computer readable medium of claim 16,
wherein said repository includes:
documents with structured fields organized in one or more nodes arranged hierarchically; and
wherein said executable instructions include instructions to
associate said free text to said structured fields via depth level information for a word corresponding to a level of said word in said hierarchy.
